(19) United States
(12) Patent Application Publication
(10) Pub. No.: US 2021/0116289 A1
(43) Pub. Date: Apr. 22, 2021

(54) Arrangement and Method for Determining a Minimum Filling Level of a Fluid in a Fluid Container

(71) Applicant: Vitesco Technologies Germany GmbH, Hannover (DE)

(72) Inventors: Karl-Friedrich Pfeiffer, München (DE); Wighard Jäger, München (DE)

(73) Assignee: Vitesco Technologies Germany GmbH, Hannover (DE)

(21) Appl. No.: 17/068,784

(22) Filed: Oct. 12, 2020

(30) Foreign Application Priority Data
Oct. 17, 2019 (DE) 10 2019 216 039.5

(51) Int. Cl. G01F 23/296

(52) U.S. Cl. CPC G01F 23/2962

(57) ABSTRACT

Various embodiments include a system for determining a filling level of a fluid comprising: a fluid container with a first wall, a second wall opposite the first, and a bottom; a transducer mounted outside the first wall at a predetermined distance from the bottom, the transducer transmitting an ultrasonic signal through the first side wall into the fluid container; a reflection element inside the fluid container reflecting the signal back to the transducer; and a control device for activating the transducer. The control device identifies a current fluid filling level greater than a minimum filling level if the signal received by the transducer is an ultrasonic signal reflected by the reflection element, and identifies a fluid filling level less than the minimum filling level if the transducer does not receive an ultrasonic signal or receives an ultrasonic signal reflected by the first side wall.

### CROSS-REFERENCE TO RELATED APPLICATIONS

This application claims priority to DE Application No. 10 2019 216 039.5 filed Oct. 17, 2019, the contents of which are hereby incorporated by reference in their entirety.

### TECHNICAL FIELD

The present disclosure relates to fluid containers. Various embodiments include arrangements and/or methods for determining or for monitoring a minimum filling level of a fluid in a fluid container with an ultrasound transducer mounted on the outer side of the fluid container wall substantially at a measuring point situated at the height of the minimum filling level to be monitored.

### BACKGROUND

Arrangements having ultrasound transducers are variously used. In particular, such arrangements are used in fluid sensor systems in order for example to qualitatively or quantitatively determine the filling level of a fluid in a container.

DE 195 38 678 A1 describes an arrangement for monitoring a predetermined filling level of a liquid in a container having an ultrasound transducer which is mounted on the outer side of the container wall at a measuring point situated at the height of the filling level to be monitored. The ultrasound transducer contains a piezoelectric element which, upon excitation by an AC voltage pulse with a predetermined transmission frequency, generates an ultrasound transmission pulse which is transmitted to the container wall via a membrane, and converts the ultrasound vibrations which are transmitted by the container wall to the ultrasound transducer into electrical receiving signals. Further arrangements of related type are known from DE 301 74 65 A1 and US 2005/072 226 A1.

### SUMMARY

The teachings of the present disclosure may include arrangements and methods for determining a minimum filling level of a fluid in a fluid container whereby the minimum filling level can be qualitatively determined and monitored. For example, some embodiments include an arrangement (100) for determining a minimum filling level of a fluid (F), comprising: a fluid container (110) in which the fluid (F) is received, wherein the fluid container (110) has a first side wall portion (112), a second side wall portion (114) opposite the first side wall portion (112), and a fluid container bottom (116) connected to the first side wall portion (112) and the second side wall portion (114), an ultrasound transducer (120) which is mounted on an outer side of the first side wall portion (112) at a predetermined distance (A) from the fluid container bottom (116) and which is designed to transmit an ultrasound signal (122) through the first side wall portion (112) into the interior of the fluid container (110), a reflection element (130) which is arranged in the interior of the fluid container (110) between the first side wall portion (112) and the second side wall portion (114) and which is designed to reflect the ultrasound signal (122) transmitted by the ultrasound transducer (120) back to the ultrasound transducer (120), and a control device for activating the ultrasound transducer (120), wherein the control device is designed to determine a fluid filling level (102) greater than or equal to the minimum filling level if the ultrasound signal (122) received by the ultrasound transducer (120) is an ultrasound signal (122) reflected by the reflection element (130), and to determine a fluid filling level less than the minimum filling level if the ultrasound transducer (120) does not receive an ultrasound signal or the ultrasound signal (122) received by the ultrasound transducer (120) is an ultrasound signal (122) reflected by the inner wall of the first side wall portion (112).

In some embodiments, the minimum filling level is equal to the predetermined distance (A) between the ultrasound transducer (120) and the fluid container bottom (116).

In some embodiments, the reflection element (130) is arranged below the predetermined distance (B) from the fluid container bottom (116).

In some embodiments, the reflection element (130) has a substantially bar-shaped reflection portion (132) which extends substantially parallel to the fluid container bottom (116) and substantially perpendicularly to the ultrasound signal (122).

In some embodiments, the reflection element (130) is fastened to a third side wall portion (118) of the fluid container (110) that connects the first side wall portion (112) to the second side wall portion (114).

In some embodiments, the reflection element (130) also has at least one fastening portion (134), wherein the reflection element (130) is fastened to the first side wall portion (112) by means of the at least one fastening portion (134).

In some embodiments, the control device is designed to determine a delay time of the ultrasound signal (122) between a transmission of the ultrasound signal and a receipt of a reflected ultrasound signal (122), wherein an ultrasound signal (122) reflected on the reflection element (130) is recognized if the determined delay time is greater than or equal to a predetermined threshold delay time, wherein an ultrasound signal (122) reflected on the inner wall of the first side wall portion (112) is recognized if the determined delay time is less than the predetermined threshold delay time.

In some embodiments, the reflection element (130) is arranged at a predetermined sound distance (C) from the first side wall portion (112), wherein the predetermined sound distance (C) is approximately 5% to approximately 70% of the distance between the first side wall portion (112) and the second side wall portion (114).

As another example, some embodiments include a method for determining a minimum filling level of a fluid (F) in a fluid container (110) in which the fluid (F) is received, wherein the fluid container (110) has a first side wall portion (112), a second side wall portion (114) opposite the first side wall portion (112), and a fluid container bottom (116) connected to the first side wall portion (112) and the second side wall portion (114), wherein an ultrasound transducer (120) is arranged on an outer side of the first side wall portion (112) at a predetermined distance (A) from the fluid container bottom (116) and is designed to transmit an ultrasound signal (122) through the first side wall portion (112) into the interior of the fluid container (110), wherein a reflection element (130) is arranged in the interior of the fluid container (110) between the first side wall portion (112) and the second side wall portion (114) and is designed to reflect the ultrasound signal (122) transmitted by the ultrasound transducer (120) back to the ultrasound transducer (120), wherein the method comprises: activating the ultrasound transducer (120) to transmit an ultrasound signal (122) into the interior of the fluid container, receiving a reflected ultrasound signal (122) by the ultrasound transducer (120), determining a fluid filling level greater than or equal to the minimum filling level if the ultrasound signal (122) received by the ultrasound transducer (120) is an ultrasound signal (122) reflected by the reflection element (130), and determining a fluid filling level less than the minimum filling level if the ultrasound transducer (120) does not receive an ultrasound signal (122) or the ultrasound signal (122) received by the ultrasound transducer (120) is an ultrasound signal (122) reflected by the inner wall of the first side wall portion (112).

In some embodiments, the method further comprises: determining a delay time of the ultrasound signal (122) between the transmission of the ultrasound signal and the receipt of a reflected ultrasound signal (122), wherein an ultrasound signal (122) reflected on the reflection element (130) is recognized if the determined delay time is greater than or equal to a predetermined threshold delay time, and wherein an ultrasound signal (122) reflected on the inner wall of the first side wall portion (112) is recognized if the determined delay time is less than the predetermined threshold delay time.

### BRIEF DESCRIPTION OF THE DRAWINGS

Further objects and features of the present disclosure will become apparent to a person skilled in the art by putting the present teaching into practice and taking into consideration the accompanying drawings, in which:

FIG. 1 illustrates a schematic view of an exemplary embodiment of an arrangement incorporating teachings of the present disclosure for determining a minimum filling level of a fluid in a fluid container;

FIG. 2 illustrates a schematic view of a further exemplary embodiment of an arrangement incorporating teachings of the present disclosure for determining a minimum filling level of a fluid in a fluid container;

FIG. 3 illustrates a plan view of a further exemplary embodiment of an arrangement incorporating teachings of the present disclosure for determining a minimum filling level of a fluid in a fluid container;

FIG. 4 illustrates a plan view of a further exemplary embodiment of an arrangement incorporating teachings of the present disclosure for determining a minimum filling level of a fluid in a fluid container;

FIG. 5 illustrates a plan view of a further exemplary embodiment of an arrangement incorporating teachings of the present disclosure for determining a minimum filling level of a fluid in a fluid container; and

FIG. 6 illustrates an exemplary flow diagram of a method incorporating teachings of the present disclosure for determining a minimum filling level of a fluid in a fluid container.

### DETAILED DESCRIPTION

The present disclosure describes mounting an ultrasound transducer on an outer wall of a fluid container at a predetermined height and simultaneously providing, inside the fluid container, a reflection element which is designed to reflect the ultrasound signals transmitted by the ultrasound transducer back again to the ultrasound transducer. If the filling level of the fluid is situated above both the reflection reflector and the ultrasound transducer, the ultrasound signals from the ultrasound transducer are coupled into the fluid through the side wall and can reach the reflection reflector before they are reflected back by the latter to the ultrasound transducer and received there as reflected ultrasound signals.

If an ultrasound signal reflected by the reflection reflector is received by the ultrasound transducer following a previous transmission, it can be qualitatively stated that the fluid filling level is above both the reflection reflector and the ultrasound transducer and hence a minimum prefilling level of the fluid is present within the container. If, however, the filling level lies below the ultrasound transducer, the ultrasound signals transmitted by the ultrasound transducer no longer reach the reflecting element. Rather, the ultrasound signals are reflected at the boundary surface between the non-fluid-filled interior region of the fluid container and the inner wall of the fluid container and pass back again to the ultrasound transducer. That is to say that, although the ultrasound waves are coupled into the side wall, they do not pass out of the wall into the non-filled interior of the fluid container but are reflected at this boundary surface. Consequently, the ultrasound transducer receives an ultrasound signal which has been reflected by the inner wall of the fluid container, whereby it can be qualitatively stated that the fluid filling level is situated below the ultrasound transducer or below the reflection element, and hence the minimum filling level is fallen short of.

Some embodiments include an arrangement for determining a minimum filling level of a fluid that has a fluid container in which the fluid is received. The fluid container comprises a first side wall portion, a second side wall portion opposite the first side wall portion, and a fluid container bottom connected to the first side wall portion and the second side wall portion. The arrangement also has an ultrasound transducer mounted on an outer side of the first side wall portion at a predetermined distance from the fluid container bottom and which is designed to transmit an ultrasound signal through the first side wall portion into the interior of the fluid container, a reflection element which is arranged in the interior of the fluid container between the first side wall portion and the second side wall portion and which is designed to reflect the ultrasound signal transmitted by the ultrasound transducer back to the ultrasound transducer, and a control device for activating the ultrasound transducer that is designed to determine a fluid filling level greater than or equal to the minimum filling level if the ultrasound signal received by the ultrasound transducer is an ultrasound signal reflected by the reflection element, and to determine a filling level less than the minimum filling level if an ultrasound signal is not received by the ultrasound transducer or the ultrasound signal received by the ultrasound transducer is an ultrasound signal reflected by the inner wall of the first side wall portion.

The arrangement thus provides a type of filling level switch. As long as the reflection element reflects an ultrasound signal transmitted by the ultrasound transducer, the minimum filling level of the fluid is present within the fluid container. As soon as the reflection element does not reflect an ultrasound signal transmitted by the ultrasound transducer, the actual fluid filling level is less than the minimum filling level of the fluid within the fluid container, and a warning can be emitted. It is thus possible for the fluid filling level to be qualitatively determined with the arrangement according to the invention.

In some embodiments, the minimum filling level is equal to the predetermined distance between the ultrasound transducer and the fluid container bottom. The minimum filling level to be monitored can thus be set as desired by correspondingly mounting the ultrasound transducer on the first side wall portion of the fluid container.

In some embodiments, the reflection element is likewise arranged below the predetermined distance from the fluid container bottom. In such an embodiment, the ultrasound transducer transmits a substantially horizontal ultrasound signal to the reflection element and also receives it again.

In some embodiments, the reflection element has a substantially bar-shaped reflection portion which extends substantially parallel to the fluid container bottom and substantially perpendicularly to the ultrasound signal.

In some embodiments, the reflection element is fastened to a third side wall portion of the fluid container that connects the first side wall portion to the second side wall portion.

In some embodiments, the reflection element also to have at least one fastening portion to which the reflection portion is connected and by means of which the reflection element is fastened to the first side wall portion.

In some embodiments, the control device is also designed to determine a delay time of the ultrasound signal between the transmission of the ultrasound signal and the receipt of the reflected ultrasound signal. An ultrasound signal reflected on the reflection element is recognized when the determined delay time is greater than or equal to a predetermined threshold delay time, whereas an ultrasound signal reflected on the inner wall of the first side wall portion is recognized when the determined delay time is less than the predetermined threshold delay time.

Therefore, the evaluation of the delay time of the ultrasound signal transmitted by the ultrasound transducer thus makes it possible to distinguish whether a reflection on the reflection element or on the inner wall of the first side wall portion of the fluid container is involved, thereby allowing the fluid filling level to be qualitatively determined with respect to the minimum filling level, that is to say whether the fluid filling level is greater than or equal to the minimum filling level or less than the minimum filling level.

In some embodiments, the reflection element within the fluid container can specifically improve the response behavior of the ultrasound transducer under dynamic conditions. Moreover, during the use of the reflection element, further structures, such as for example baffles or other calming structures, can be arranged between said reflection element and the second side wall portion opposite the first side wall portion of the fluid container, without compromising the functionality of the arrangement according to the invention for filling level monitoring. Moreover, the configuration of the second side wall portion of the fluid container can be independent of the measuring function of the arrangement.

In some embodiments, the reflection element to be arranged at a predetermined sound distance from the first side wall portion. The predetermined sound distance may be approximately 5% to approximately 70% of the distance between the first side wall portion and the second side wall portion. In some embodiments, the sound distance is only insignificantly larger than the minimum distance from the ultrasound transducer necessary to recognize the reflected ultrasound signal. In principle, this minimum distance is present in echo delay time measurements and dependent in terms of its size on the specific technical design of the measuring arrangement.

In some embodiments, there is a method for determining a minimum filling level of a fluid in a fluid container in which the fluid is received. The fluid container has a first side wall portion, a second side wall portion opposite the first side wall portion, and a fluid container bottom connected to the first side wall portion and the second side wall portion. An ultrasound transducer is arranged on an outer side of the first side wall portion at a predetermined distance from the fluid container bottom and is designed to transmit an ultrasound signal through the first side wall portion into the interior of the fluid container. A reflection element is arranged in the interior of the fluid container between the first side wall portion and the second side wall portion and is designed to reflect the ultrasound signal transmitted by the ultrasound transducer back to the ultrasound transducer.

In some embodiments, the method comprises an activation of the ultrasound transducer to transmit an ultrasound signal into the interior of the fluid container, a receipt of a reflected ultrasound signal by means of the ultrasound transducer, and a determination of a fluid filling level greater than or equal to the minimum filling level if the ultrasound signal received by the ultrasound transducer is an ultrasound signal reflected by the reflection element, or a determination of a fluid filling level less than the minimum filling level if an ultrasound signal is not received by the ultrasound transducer or the ultrasound signal received by the ultrasound transducer is an ultrasound signal reflected by the inner wall of the first side wall portion.

In some embodiments, the method further comprises determining a delay time of the ultrasound signal between the transmission of the ultrasound signal and the receipt of the reflected ultrasound signal. Here, an ultrasound signal reflected on the reflection element is recognized if the determined delay time is greater than or equal to a predetermined threshold delay time, and an ultrasound signal reflected on the inner wall of the first side wall portion is recognized if the determined delay time is less than the predetermined threshold delay time.

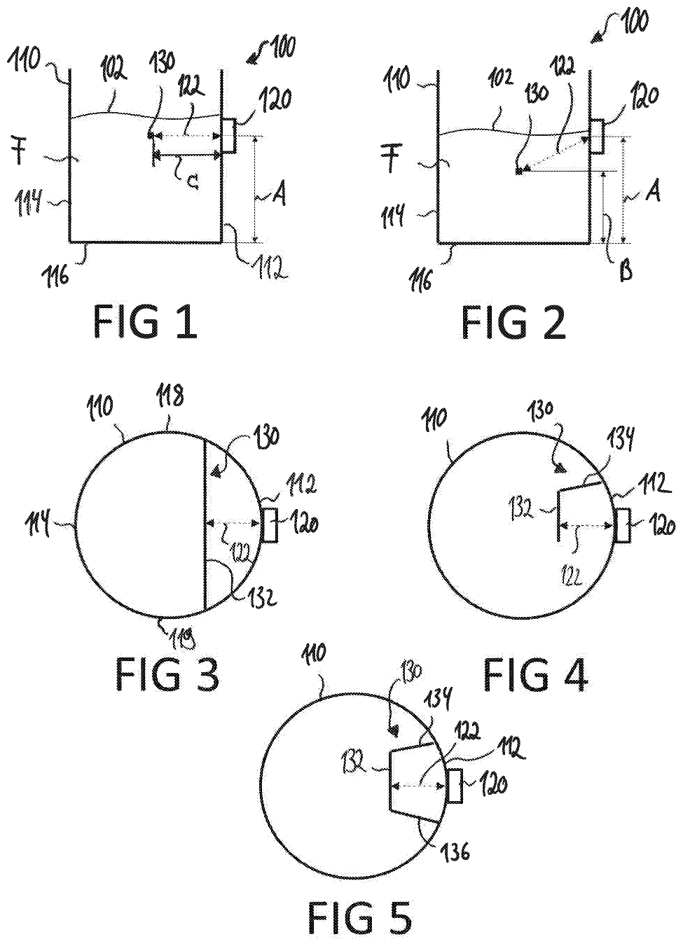

FIG. 1 shows an exemplary embodiment of an arrangement 100 incorporating the teachings herein having a fluid container 110 and a fluid F situated therein. The fluid F is for example a liquid medium for pollutant reduction in exhaust gases, which may contain a reducing agent and/or a reducing agent precursor, for example an aqueous urea solution. In some embodiments, the fluid F can be an oil, such as for example a transmission oil for a transmission of a vehicle. In addition, the fluid F can be an engine oil or a fuel. The arrangement 100 can equally be used for water or aqueous solutions which are intended for example for window cleaning or arise as a reaction product during the operation of a fuel cell.

The fluid container 110 has a first side wall portion 112, a second side wall portion 114 opposite the first side wall portion 112, and a fluid container bottom 116 connected to the first side wall portion 112 and the second side wall portion 114. In the fluid container 110 of FIG. 1, the fluid F has a fluid filling level 102. The arrangement 100 of FIG. 1 further comprises an ultrasound transducer 120 which is mounted on an outer side of the first side wall portion 112 at a predetermined distance A from the fluid container bottom 116 and which is designed to transmit an ultrasound signal through the first side wall portion 112 into the interior of the fluid container 110. Here, the predetermined distance A can also simultaneously represent the minimum filling level which is intended to be monitored by the arrangement 100 and can be set as desired.

The ultrasound transducer 120 contains for example a piezoelectric element which, upon excitation by an AC voltage pulse with a predetermined transmission frequency, generates an ultrasound transmission pulse (ultrasound signal) which is transmitted to the first side wall portion 112, and converts the ultrasound vibrations which are transmitted by the first side wall portion 112 to the ultrasound transducer 120 into electrical receiving signals. Consequently, the ultrasound converter 120 can function as a transmitter and receiver of ultrasound signals. Instead of a piezoelectric element, it is also possible to use ultrasound transducers of other designs.

The arrangement 100 additionally has a reflection element 130 which is arranged in the interior of the fluid container 110 and which, in the embodiment of FIG. 1, is likewise spaced apart from the fluid container bottom 116 at the predetermined distance A. The reflection element 130 is designed to reflect the ultrasound signals transmitted by the ultrasound transducer 120 into the fluid F back again to the ultrasound transducer 120. The reflection element 130 can have a rectangular, square, circular, oval or any other suitable cross section which is designed to reflect ultrasound signals back again. The reflection element 130 has a planar portion which can reflect the ultrasound signals impinging thereon.

According to the embodiment as per FIG. 1, the ultrasound transducer 120 transmits ultrasound signals into the interior of the fluid container 110 substantially in a horizontal direction. In some embodiments, the ultrasound transducer 120 may transmit ultrasound signals running substantially perpendicularly to the side wall portion 112.

The arrangement 110 also has a control device designed to activate the ultrasound transducer 120 and evaluate any signals of the ultrasound transducer 120. In particular, the control device is designed to determine whether a reflection of the ultrasound signal transmitted by the ultrasound transducer 120 is present on the reflection element 130 or on the inner wall of the first side wall portion 112. If, as shown in FIG. 1, the fluid filling level 102 is situated above both the ultrasound transducer 120 and the reflection element 130, the ultrasound signals transmitted by the ultrasound transducer 120 can pass through the first side wall portion 112 and be coupled into the fluid F, where they can be transmitted from there through the fluid F to the reflection element 130. The ultrasound signals are reflected on the reflection element 130 and pass back again through the fluid F and the side wall portion 112 to the ultrasound transducer 120, where they are detected by the ultrasound transducer 120 as reflected ultrasound signal. In the figures, the path of the ultrasound signal is denoted as arrow 122.

If, however, the fluid filling level 102 is situated below both the reflection element 130 and the ultrasound transducer 120, the ultrasound signals transmitted by the ultrasound transducer 120 are already reflected at the interface between the inner wall of the first side wall portion 112 and the interior of the fluid container 110 that is not filled at this measuring point, and pass from there back again to the ultrasound transducer 120, where they are in turn detected by the ultrasound transducer 120 as reflected ultrasound signal.

Even if, on account of external influences (for example movement or inclination of the fluid container 110), only some of the section between the ultrasound transducer 120 and reflection element 130 is filled with the fluid, it is not possible for an ultrasound signal of the ultrasound transducer 120 to propagate to the reflection element 130 and back again.

The control device can then determine, for example on the basis of an evaluation of the delay time of the ultrasound signal, whether a reflection on the reflection element 130 or a reflection on the inner wall of the first side wall portion 112 is involved and conclude therefrom whether the fluid filling level 102 is greater than or equal to or less than the minimum filling level. If the ultrasound signal 122 received by the ultrasound transducer 120 is an ultrasound signal reflected by the reflection element 130, a fluid filling level 102 greater than or equal to the minimum filling level A is determined. By contrast thereto, a fluid filling level less than the minimum filling level is determined if the ultrasound signal 122 received by the ultrasound transducer 120 is an ultrasound signal reflected by the inner wall of the first side wall portion 112.

The reflection element 130 is also arranged at a predetermined sound distance C from the first side wall portion 112. The predetermined sound distance C is approximately 5% to approximately 70% of the distance between the first side wall portion 112 and the second side wall portion 114. In some embodiments, the sound distance is only insignificantly larger than the minimum distance from the ultrasound transducer 120 necessary to recognize the reflected ultrasound signal.

With reference to FIG. 2, there is illustrated a further exemplary embodiment of an arrangement 100 incorporating teachings of the present disclosure for determining a minimum filling level of a fluid F in a fluid container 110. The arrangement 100 of FIG. 2 differs from the arrangement 100 of FIG. 1 in that the reflection element 130 has a predetermined distance B from the fluid container bottom 116 that is less than the predetermined distance A of the ultrasound transducer 120 from the fluid container bottom 116. Moreover, the ultrasound transducer 120 does not transmit ultrasound signals perpendicularly to the inner wall of the first side wall portion 112 but ultrasound signals which run at a predetermined angle to the inner wall of the first side wall portion 112.

Here, too, the control device can perform the evaluation of the reflection signals as already described with regard to FIG. 1, with a reflection on the reflection element 130 being allowed only when the filling level 102 lies above the ultrasound transducer 120, or the whole section between the ultrasound transducer 120 and reflection element 130 is filled with the fluid.

The arrangement according to FIG. 2 may be used when, during operation, the fluid container frequently or permanently has an inclined position such that the fluid surface frequently or permanently runs parallel to the path 122 of the ultrasound signal.

In some embodiments, the reflection element 130 is arranged at a predetermined distance from the fluid container bottom 116 that is greater than the predetermined distance A of the ultrasound transducer 120 from the fluid container bottom 116. In such an embodiment, a reflection on the reflection element 130 can occur only when the filling level 102 lies above the reflection element 130 or the whole section between the ultrasound transducer 120 and reflection element 130 is filled with the fluid.

With reference to FIG. 3 to FIG. 5, plan views of the fluid container 110 of FIG. 1 are illustrated in each case, with FIGS. 3 to 5 differing in that the reflection element 130 in each case has different configurations and fastenings.

It is shown in FIG. 3 that the reflection element 130 has a substantially bar-shaped reflection portion 132 which extends substantially parallel to the fluid container bottom 116 and substantially perpendicularly to the ultrasound signal 122. In particular, the reflection element 130 of FIG. 3 extends from a third side wall portion 118, which connects the first side wall portion 112 to the second side wall portion 114, up to an opposite fourth side wall portion 119 of the fluid container 110.

The reflection element 130 of FIG. 4 has a substantially bar-shaped reflection portion 132 and a fastening portion 134 by means of which the reflection element 130 is fastened to the first side wall portion 112. Alternatively, the fastening portion 134 can be fastened to the third side wall portion 118 or to the fourth side wall portion 119. Moreover, it can be preferable, to improve the stability of the reflection element 130, for there to be provided a further fastening portion 136 by means of which the reflection element 130 is again mounted on the first side wall portion 112 (see FIG. 5). Here, too, the further fastening portion 136 can alternatively be fastened to the third side wall portion 118 or to the fourth side wall portion 119.

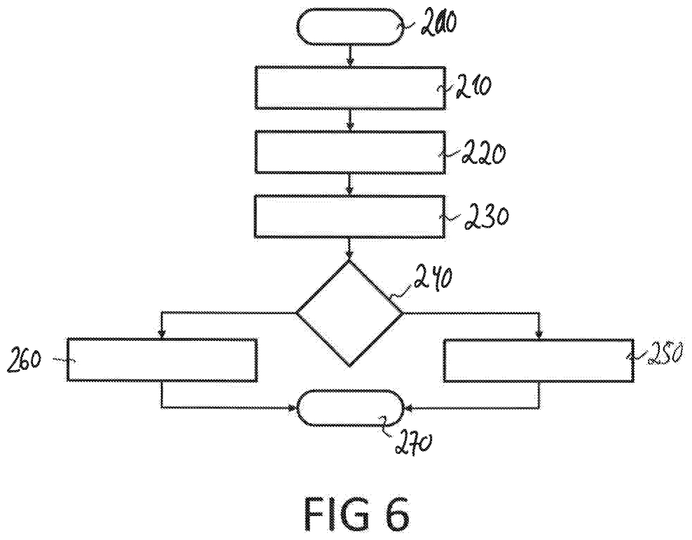

FIG. 6 shows an exemplary flow diagram of a method incorporating teachings of the present disclosure for determining a minimum filling level of a fluid in a fluid container. For example, reference is now made therein to FIG. 1 and the arrangement 100 shown therein. The method of FIG. 6 starts with step 200 and then passes to step 210 at which the control device activates the ultrasound transducer 120 in such a way that it transmits an ultrasound signal 122 through the first side wall portion 112 in the direction of the reflection element 130.

In a subsequent step 220, a reflected ultrasound signal is received by means of the ultrasound transducer 120. In a further step 230, the control device is designed to determine the delay time of the ultrasound signal between the ultrasound signal transmitted in step 210 and the ultrasound signal received at step 220.

It is subsequently checked in step 240 whether the delay time of the ultrasound signal determined at step 230 is greater than a predetermined delay time threshold value. If it is determined in step 240 that the determined delay time is greater than or equal to the determined delay time threshold, the method passes to step 250 at which it is determined that the filling level 102 of the fluid F within the fluid container 110 is greater than or equal to the minimum filling level A.

If, by contrast, it is determined in step 240 that the determined delay time of the ultrasound signal is less than the determined delay time threshold, the method passes to step 260 at which it is determined that the filling level 102 of the fluid F in the fluid container 110 is less than the minimum filling level A.

After steps 250, 260, the method passes in each case to step 270 and is terminated.

1. A system for determining a filling level of a fluid, the system comprising:
a fluid container holding the fluid, wherein the fluid container has a first side wall, a second side wall opposite the first side wall, and a bottom connected to the first side wall and the second side wall portion;
a transducer mounted on an outer side of the first side wall at a predetermined distance from the bottom, the transducer transmitting an ultrasonic signal through the first side wall into the fluid container;
a reflection element arranged in the fluid container between the first side wall and the second side wall, the reflection element reflecting the ultrasonic signal back to the transducer; and
a control device for activating the transducer;
wherein the control device identifies a current fluid filling level greater than or equal to a minimum filling level if the ultrasonic signal received by the transducer is an ultrasonic signal reflected by the reflection element, and identifies a fluid filling level less than the minimum filling level if the transducer does not receive an ultrasonic signal or receives an ultrasonic signal reflected by the first side wall.

2. The system as claimed in claim 1, wherein the minimum filling level is equal to the predetermined distance between the transducer and the bottom.

3. The system as claimed in claim 1, wherein the reflection element is arranged below the predetermined distance from the fluid container bottom.

4. The system as claimed in claim 1, wherein the reflection element includes a substantially bar-shaped reflection portion extending parallel to the bottom and perpendicularly to the ultrasound signal generated by the transducer.

5. The system as claimed in claim 1, wherein the reflection element is fastened to a third side wall of the fluid container connecting the first side wall to the second side wall.

6. The system as claimed in claim 1, wherein the reflection element includes a fastening portion holding the reflection element to the first side wall.

7. The system as claimed in claim 1, wherein:
the control device determines a delay time of the ultrasonic signal between transmission of the ultrasonic signal and receipt of a reflected ultrasonic signal;
an ultrasonic signal reflected by the reflection element is identified if the determined delay time is greater than or equal to a predetermined threshold delay time; and
an ultrasound signal reflected from the first side wall is identified if the determined delay time is less than the predetermined threshold delay time.

8. The system as claimed in claim 1, wherein:
the reflection element is arranged at a predetermined sound distance from the first side wall; and
the predetermined sound distance is between 5% and 70% of a distance between the first side wall and the second side wall.

9. A method for determining a filling level of a fluid in a fluid container, wherein the fluid container has a first side wall, a second side wall opposite the first side wall, and a bottom connected to the first side wall and the second side wall, wherein a transducer is arranged on an outer side of the first side wall at a predetermined distance from the bottom and is transmits an ultrasonic signal through the first side wall into the fluid container, wherein a reflection element is arranged in the fluid container between the first side wall and the second side wall and reflects the ultrasonic signal back to the transducer, wherein the method comprises:
activating the transducer to transmit an ultrasonic signal into the fluid container;
receiving a reflected ultrasonic signal at the transducer;
identifying a fluid filling level greater than or equal to a minimum filling level if the ultrasonic signal received at the transducer is reflected from the reflection element; and
identifying a fluid filling level less than the minimum filling level if the transducer does not receive an ultrasound signal or receives an ultrasonic signal reflected from the first side wall.

10. The method as claimed in claim 9, further comprising determining a delay time between transmission of the ultrasonic signal and receipt of a reflected ultrasonic signal;
wherein an ultrasonic signal reflected by the reflection element is recognized if the determined delay time is greater than or equal to a predetermined threshold delay time; and
wherein an ultrasonic signal reflected by the first side wall is recognized if the determined delay time is less than the predetermined threshold delay time.
